(19) United States
(12) Patent Application Publication
(10) Pub. No.: US 2011/0173352 A1
(43) Pub. Date: Jul. 14, 2011

(54) Power Reduction on Idle Communication Lanes

(75) Inventors: Oren Sela, Rosh Pina (IL); Hillel Chapman, Ein Ha'Emek (IL); Ran Ravid, Tel Aviv (IL)

(73) Assignee: MELLANOX TECHNOLOGIES LTD, Yokneam (IL)

(21) Appl. No.: 12/686,401

(22) Filed: Jan. 13, 2010

(51) Int. Cl. G06F 3/00

(52) U.S. Cl. 710/16

(57) ABSTRACT

A method for communication includes establishing a full-duplex communication link between first and second nodes. The link includes multiple first lanes for conveying first communication traffic in a first link direction and multiple second lanes for conveying second communication traffic in a second link direction. Signals are exchanged between the first and second nodes to indicate a requested change in lane activity in the first link direction. Responsively to the signals, a number of the first lanes that are active is changed so that the first node conveys the first communication traffic to the second node over a first number of the first lanes, while the second node conveys the second communication traffic to the first node over a second number of the second lanes, which is different from the first number.

### FIELD OF THE INVENTION

The present invention relates generally to communication systems, and specifically to methods and devices for controlling power consumption in multi-lane communication links.

### BACKGROUND OF THE INVENTION

Power-save modes are mandated in various communication standards. Typically, when there is no traffic on a given link between a pair of network nodes, one of the nodes signals to the other to request a transition to the power-save mode. When the other node signals its agreement, the rate of data transmission over the link is reduced, thereby reducing power consumption by the node. When the link traffic subsequently increases, the nodes again exchange mode transition signaling, and full-rate data transmission is resumed.

U.S. Pat. No. 7,136,953, whose disclosure is incorporated herein by reference, describes a method for bus link width optimization, in which the number of active serial data lanes of a data bus is re-negotiated in response to changes in bus bandwidth requirements. The data bus permits the number of active data lanes of the data link to be adaptively adjusted in response to changes in bus bandwidth requirements. The bus is configured to have a sufficient number of active lanes to provide a high bandwidth for operational states requiring high bandwidth. For operational states requiring less bandwidth, however, the bus is configured to have a smaller number of active lanes sufficient to supply the reduced bandwidth requirement of the operational state, reducing the bus power requirements.

### SUMMARY

Embodiments of the present invention that are described hereinbelow provide methods and systems in which the number of active lanes in a full-duplex link is controlled asymmetrically over the two link directions.

There is therefore provided, in accordance with an embodiment of the present invention, a method for communication, including establishing a full-duplex communication link between first and second nodes. The link includes multiple first lanes for conveying first communication traffic in a first link direction from the first node to the second node and multiple second lanes for conveying second communication traffic in a second link direction from the second node to the first node. Signals are exchanged between the first and second nodes to indicate a requested change in lane activity in the first link direction. Responsively to the signals, the number of the first lanes that are active is changed so that the first node conveys the first communication traffic to the second node over a first number of the first lanes, while the second node conveys the second communication traffic to the first node over a second number of the second lanes, which is different from the first number.

In a disclosed embodiment, the link includes equal numbers of the first and second lanes.

In some embodiments, exchanging the signals includes detecting a status of the first communication traffic, and initiating an exchange of the signals responsively to the status. Detecting the status may include detecting, at the first node, a level of a queue of packets for transmission by the first node. Upon detecting that the queue is empty, changing the number may include deactivating one or more of the first lanes.

In a disclosed embodiment, changing the number of the first lanes includes deactivating all but a single one of the first lanes, so that the first communication traffic is transmitted over the single one of the first lanes while the second communication traffic is transmitted over the multiple second lanes.

Alternatively or additionally, the first number may be greater than one and less than a total number of the first lanes.

Typically, changing the number of the first lanes includes setting the first and second numbers independently of one another. Additionally or alternatively, the method may include changing a data rate of one or more of the first lanes that are active.

There is also provided, in accordance with an embodiment of the present invention, communication apparatus, including an interface, which is configured to communicate via a full-duplex link with a communication node. The link includes multiple first lanes for conveying first communication traffic in a first link direction from the interface to the communication node and multiple second lanes for conveying second communication traffic in a second link direction from the communication node to the interface. A controller is configured to exchange signals with the communication node with respect to a requested change in lane activity in one of the first and second link directions, and responsively to the signals, to change a number of the lanes that are active in the one of the first and second link directions so that the interface conveys the first communication traffic to the communication node over a first number of the first lanes, while the communication node conveys the second communication traffic to the interface over a second number of the second lanes, which is different from the first number.

There is additionally provided, in accordance with an embodiment of the present invention, a communication system, including first and second nodes, which are coupled to communicate via a full-duplex communication link, including multiple first lanes for conveying first communication traffic in a first link direction from the first node to the second node and multiple second lanes for conveying second communication traffic in a second link direction from the second node to the first node. The first and second nodes are configured to exchange signals to indicate a requested change in lane activity in the first link direction and responsively to the signals, to change a number of the first lanes that are active so that the first node conveys the first communication traffic to the second node over a first number of the first lanes, while the second node conveys the second communication traffic to the first node over a second number of the second lanes, which is different from the first number.

The present invention will be more fully understood from the following detailed description of the embodiments thereof, taken together with the drawings in which:

### BRIEF DESCRIPTION OF THE DRAWINGS

FIG. 1 is a block diagram that schematically illustrates a multi-lane communication system, in accordance with an embodiment of the present invention;

FIG. 2 is a flow chart that schematically illustrates a method for changing the number of active lanes in a communication link, in accordance with an embodiment of the present invention; and

FIGS. 3 and 4 are state diagrams that schematically illustrate activity states of a node in a communication system, in accordance with an embodiment of the present invention.

### DETAILED DESCRIPTION OF EMBODIMENTS

### Overview

In some communication standards, a high-speed link between two nodes comprises multiple parallel lanes. The term “lane,” in the context of the present patent application and in the claims, refers to a simplex (unidirectional) communication channel comprising a dedicated transmitter at one node and a dedicated receiver at the other, connected by a tangible transmission medium, such as a wire pair or optical fiber. For example, Gigabit Ethernet links operating at 40 Gb/s and 100 Gb/s may include as many as twenty lanes. The IEEE 802.3ba draft standard defines a Physical Coding Sublayer (PCS) within the Ethernet physical layer (PHY) for distributing traffic among these lanes. Similarly, 40 Gb/s InfiniBand™ links may be made up of four parallel 10 GB/s lanes.

A full-duplex, multi-lane link includes one set of lanes for conveying traffic in one direction and another set of lanes for the opposite direction. Transmit logic at the transmitting node distributes data traffic over the active lanes; and receive logic at the receiving node typically multiplexes the traffic into a single data stream. A lane is referred to as “active,” in the context of the present patent application and in the claims, when it is configured in the transmit logic to transmit data traffic. In embodiments of the present invention, at any given time, all of the lanes in a given direction may be active, or only a subset of the lanes may be active. Inactive lanes may be powered down at the transmitter and, typically, at the receiver, as well, in order to reduce power consumption.

Full-duplex links within high-speed computer networks are generally configured symmetrically in hardware, with an equal number of lanes available in each direction. In many applications, however, the specific data transmission needs are highly asymmetrical. For example, when data are copied in bulk from a source node to a target node, there is typically a high data rate on the link only from the source node to the target node. The opposite link direction carries control traffic, such as periodic acknowledgments and other signaling, at a low data rate from the target node to the source node.

Embodiments of the present invention that are described hereinbelow address this sort of situation by providing methods and devices that can be used to maintain a different number of active lanes in each of the link directions. The nodes at the ends of the link exchange signals to indicate requested changes in lane activity status in each direction independently. The nodes thus change the number of the active lanes in each of the two link directions as required, in response to data transmission needs. The deactivated lanes may be powered down in order to reduce power consumption and excess heat generation at the nodes, and they may subsequently be powered back up and reactivated when data traffic increases. Optionally, the data rates of the active lanes may also be individually controlled.

Thus, in the above example of data copying, all lanes from the source node to the target node may be kept active for rapid data transfer, while all but one lane from the target node to the source node are deactivated, leaving only the single lane open for the necessary control traffic. Alternatively, in other situations, different numbers of the lanes, which may be greater than one while less than the total number of lanes available, may be kept active in one or both link directions. The number of open lanes may be determined based on the traffic level in each direction, or possibly on other link management considerations.

### System Description

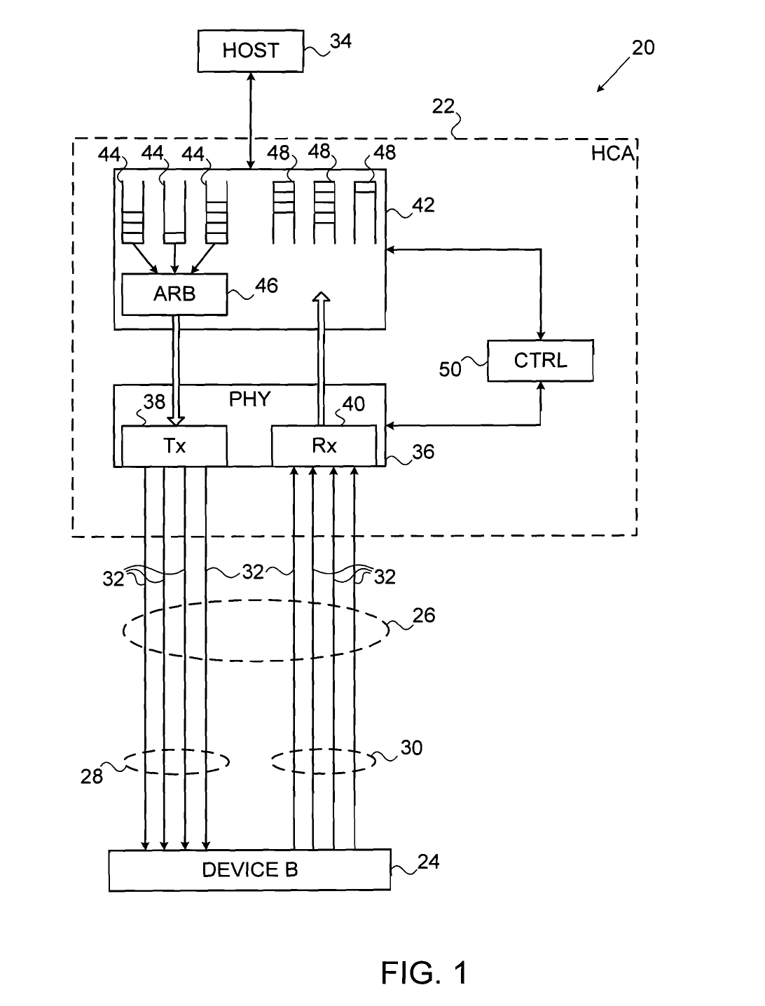

FIG. 1 is a block diagram that schematically illustrates a multi-lane communication system 20, in accordance with an embodiment of the present invention. System 20 comprises two nodes: a host channel adapter (HCA) 22 and another network device 24 (identified as “DEVICE B”), such as a switch or another HCA, which are connected by a link 26. In this example, it will be assumed that the elements of system 20 operate in accordance with InfiniBand standards, but the principles of this embodiment are equally applicable in systems using other types of multi-lane links, such as 40 and 100 Gb Ethernet and PCI Express links.

Link 26 comprises two simplex sub-links 28 and 30. Sub-link 28 carries data traffic in one link direction, from HCA 22 to device 24, while sub-link 30 carries data traffic in the opposite link direction. Each of the sub-links comprises multiple lanes 32. (In the present example, each sub-link comprises four lanes, but larger or smaller numbers of sub-lanes may alternatively be provided.) Lanes 32 are managed by a physical layer interface (PHY) 36 in HCA 22 and by a similar interface (not shown) in device 24. These interfaces may also be referred to as ports. While system 20 is operational, any number of the lanes, between one and all four, may be active. Interface 36 selects the lanes that are to be in the active state at any given time, in cooperation with the corresponding interface in device 24. The transmit logic of HCA 22 distributes outgoing data traffic among the active lanes of sub-link 28, while the receive logic accepts and multiplexes the incoming data traffic from the active lanes of sub-link 30.

HCA 22 in this example provides communication services to a host processor 34. In response to work requests from the host processor, a protocol processor 42 in HCA 22 queues outgoing data packets in one or more transmit queues 44, and an arbiter 46 selects the packets from the queues for transmission by transmit logic 38 in interface 36. Receive logic 40 places incoming packets in receive queues 48 for processing by the protocol processor.

A controller 50 monitors the status of outgoing communication traffic in transmit queues 44 and passes control instructions accordingly to interface 36. The controller may comprise, for example, an embedded microprocessor or programmable logic array. Typically, upon discovering that the transmit queues are low or empty (and have remained so for at least some threshold period), controller 50 instructs interface 38 to deactivate one or more of lanes 32 on sub-link 28. Alternatively, if queues 44 are filling and not all the lanes are active, the controller may instruct interface to activate one or more of the inactive lanes. To effect the change in the number of active lanes, interface 36 exchanges signaling with the corresponding interface in device 24 at the other end of sub-link 28. Details of this process are described hereinbelow.

A similar process takes place in the opposite link direction, over the lanes of sub-link 30, at the initiation of device 24. The number of active lanes is thus set in each link direction depending on the respective traffic level, independently of the other link direction.

### Methods for Controlling Lane Activity

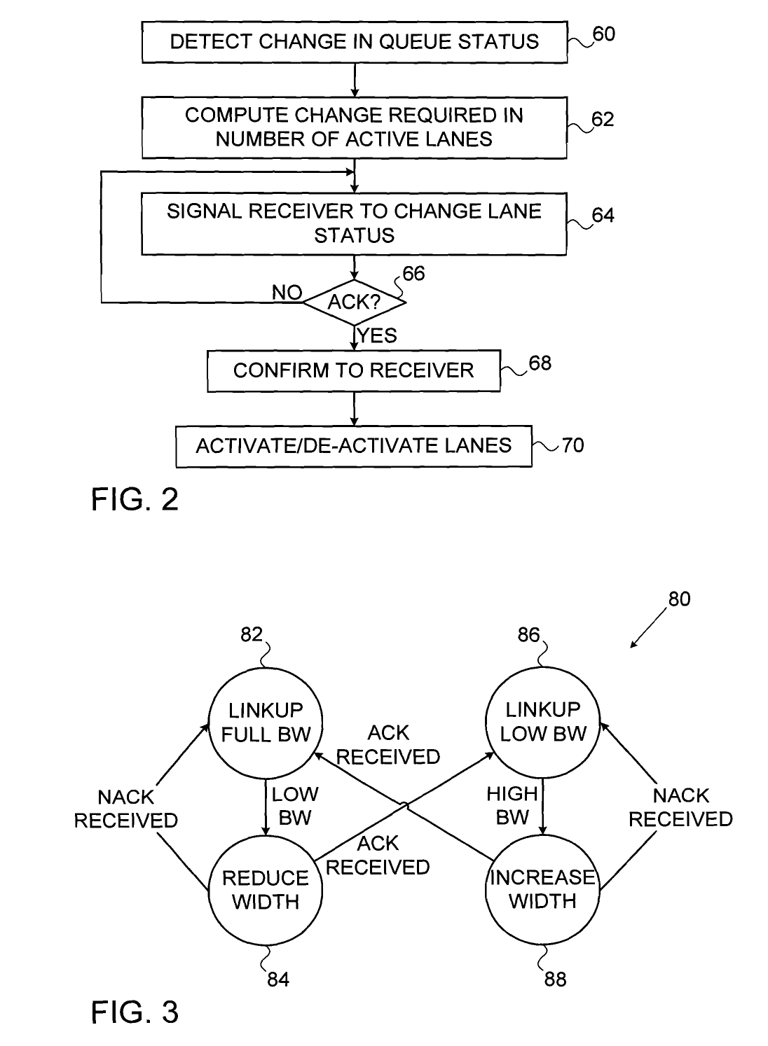

FIG. 2 is a flow chart that schematically illustrates a method for changing the number of active lanes in a communication link, in accordance with an embodiment of the present invention. The method is described here, for the sake of convenience and clarity, with reference to the elements of system 20 (FIG. 1), but it may similarly be applied to other suitable types of multi-lane communication links. The method is initiated when controller 50 detects a change in the status of transmit queues 44, at a status detection step 60. For example, the controller may detect that the queues have been empty for some time, or alternatively that the lengths of one or more of the queues are above a predefined limit.

Based on the queue status, controller 50 computes the change required in the number of active lanes 32 on sub-link 28, at a change computation step 62, and passes instructions to interface 36 to make the change. At the simplest level, the controller may decide to switch between a full-bandwidth state, in which all of the lanes are active, and a low-bandwidth state, in which only a single lane is active, or vice versa. Alternatively, the controller may choose any number of the lanes to be active or inactive at any given time. Further alternatively or additionally, the controller may instruct interface 36 to change the data rate of one or more of the active lanes. The controller's choice of the number of active lanes and their data rates may depend not only on the traffic level, but also on other factors, such as the temperature of the system or power limitation of the system.

Upon receiving an instruction to change the number of active lanes, interface 36 signals the desired change to the receiver in device 24, in a signaling step 64. On an InfiniBand link, for example, the signaling may take the form of a training sequence, i.e., a sequence of symbols that is transmitted over the link to invoke a status change. The sequence includes instructions that identify the lane or lanes in question and the operation (activate/deactivate) to be performed. A width change command block that may be used, for example, on multi-lane Ethernet links for 40 Gb/s or 100 Gb/s Ethernet is shown below in an Appendix.

The interface in device 24 acknowledges the status change request by transmitting an acknowledgment (ACK) sequence over sub-link 30, at an acknowledgement step 66. The acknowledgment sequence may be similar to the training sequence mentioned above, but with a different operation code. Alternatively, the receiver may return a negative acknowledgment (NACK) if it is not prepared to make the activity status change. If interface 36 in HCA 22 does not receive the desired ACK at step 66, it may repeat step 64 until a positive acknowledgment is received. As a further alternative, the receiver may not be allowed to return a NACK, in which case the ACK may serve simply for purposes of synchronization. In this case, interface 36 may change the number of active lanes immediately after step 64, without waiting for acknowledgment from device 24. Upon receiving a positive acknowledgment, interface 36 may optionally stop transmission over sub-link 28 temporarily and send a confirmation to device 24, at a confirmation step 68.

In response to the above signaling, transmit logic and the corresponding receive logic in device 24 activate or deactivate the appropriate lanes, at an activity change step 70, and then continue transmission over the active lanes. Deactivated lanes are typically powered down, i.e., supply voltage and clock circuits for the lanes in question are either switched off or switched to reduced levels, in order to reduce power consumption.

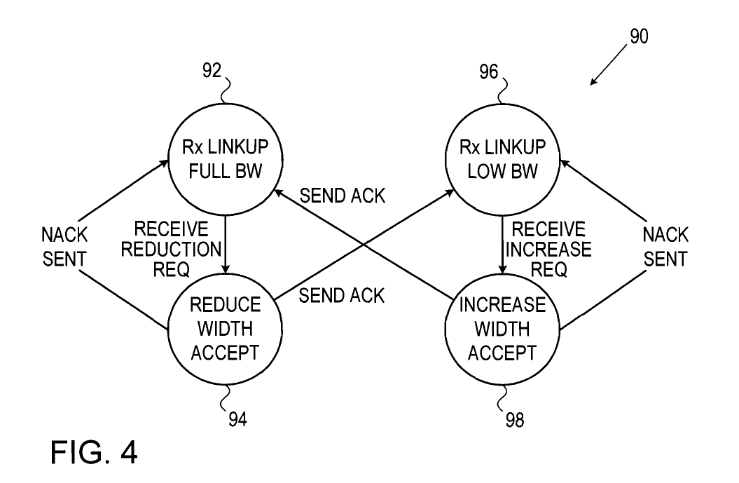

FIG. 3 is a state diagram 80 that schematically illustrates activity states of transmit logic 38 in HCA 22, in accordance with an embodiment of the present invention. This example, as well as the example shown below in FIG. 4, refers to the simple case in system 20 in which link 24 has only two types of lane configurations: full bandwidth, with all lanes active, and low bandwidth, with a lower number (one or more) of lanes active. The principles of this embodiment, however, may be extended in a straightforward way to other systems and other, more complex state arrangements. The states shown in FIGS. 3 and 4 are sub-states of a “LINK-UP” super-state, in which link 26 is operational, while other link states that are part of normal link behavior (such as LINK-DOWN and RECOVERY after failure) but do not relate directly to controlling the number of active lanes in the link are omitted here for the sake of simplicity. The state transitions shown in the figures may be completely transparent to system software, applications and even fabric management, since the link status remains in the LINK-UP super-state.

At power-up, transmit logic 38 normally enters a full bandwidth (BW) state 82, in which all lanes are active. (Alternatively, in power-sensitive systems, the network interfaces may power-up to a low-bandwidth state and then activate lanes as needed.) When controller 50 indicates that the number of active lanes should be reduced, the transmit logic enters a reduce width state 84, in which it signals a request to device 24 to reduce the number of active lanes on sub-link 28. The transmit logic remains in state 84 until interface 36 receives an acknowledgment from device 24, or until it receives a NACK or controller 50 indicates that the lane reduction is no longer desirable. In the latter cases, the transmit logic returns to state 82.

Upon receiving a positive acknowledgment in state 84, transmit logic 38 enters a low bandwidth state 86, in which the number of active lanes is reduced, as described above. The transmit logic remains in state 86 until controller 50 indicates that the number of active lanes should again be increased. At this point, the transmit logic enters an increase width state 88, in which it signals a request to device 24 to return to the full complement of active lanes. The transmit logic remains in state 88 until interface 36 receives a positive acknowledgment from device 24, whereupon all lanes 32 on sub-link 28 are powered up and the transmit logic enters state 82. Otherwise, upon receiving a NACK or indication that the lane increase is not needed, the transmit logic returns to state 86.

FIG. 4 is a state diagram 90 that schematically illustrates activity states of receive logic 40 in HCA 22, in accordance with an embodiment of the present invention. As in diagram 80, the receive logic begins in a full bandwidth state 92. Upon receiving a signal from device 24 requesting a reduction in the number of active lanes, the receive logic enters a reduced width acceptance state 94. In this state, interface 36 evaluates whether the lane reduction should be carried out. If not, interface 36 sends a NACK (if allowed) to device 24, and the receive logic returns to state 92.

When receive logic 40 in state 94 is ready and able to perform the lane reduction, interface 36 sends a positive acknowledgment to device 24, and the receive logic enters a low bandwidth state 96, in which the number of active lanes on sub-link 30 is reduced. The receive logic remains in state 96 until it receives a signal from device 24 requesting that the number of active lanes be increased. In response to this request, the receive logic enters a width increase acceptance state 98. In this state, the receive logic powers up all of lanes 32 on sub-link 30. When power-up is successful, interface 36 sends a positive acknowledgment to device 24. The receive logic then returns to state 92, in which all lanes are active. Otherwise, interface 36 sends a NACK to device 24, and the receive logic returns to state 96.

It will be appreciated that the embodiments described above are cited by way of example, and that the present invention is not limited to what has been particularly shown and described hereinabove. Rather, the scope of the present invention includes both combinations and subcombinations of the various features described hereinabove, as well as variations and modifications thereof which would occur to persons skilled in the art upon reading the foregoing description and which are not disclosed in the prior art.

### APPENDIX

### Width Change Block for 40/100 Gigabit Ethernet

This Appendix presents an example of a 66-bit width change block that may be transmitted over a multi-lane 40/100 Gigabit Ethernet link in order to change the number of active lanes:

| 2 | 8 | | | | | | |
|---|---|---|---|---|---|---|---|
| bits | bits | 56 bits | | | | | |
| Synch | Type | 55:48 | 47:40 | 39:32 | 31:24 | 23:16 | 15:0 |
| 10 | 0x5A | Verify = 0x72 | type | width | speed | ack | res |

The fields of the above block are interpreted as follows, wherein the term “width” refers to the number of active lanes:

| Bits | Size | Name | Description |
|---|---|---|---|
| 65:64 | 2 | Synch | Synch header. Value is 10b. |
| 63:56 | 8 | Type | Block Type. |
| | | | Using a reserved value of 0x5A. |
| 55:48 | 8 | Verify | Verify is used to prevent |
| | | | accidental block being recognized |
| | | | as BW change block. |
| | | | Verify value is 0x72. Blocks with |
| | | | any other value are ignored. |
| 47:40 | 8 | MS_type | This field defines the type of |
| | | | the message: |
| | | | 0x0 - width reduction (default is |
| | | | x1). |
| | | | 0x1 - width increase (default is |
| | | | return to max). |
| | | | 0x2 - speed reduction (default is |
| | | | HHDR [half half data rate]). |
| | | | 0x3 - speed increase (default is |
| | | | max speed). |
| | | | 0x4 - change complete. |
| | | | 0x5-0xE - reserved. |
| | | | 0xF - ACK - accept the request |
| | | | that was received. |
| 39:32 | 8 | Width | 0x0 - use default |
| | | | 0x1-x1 width |
| | | | 0x2-x2 width |
| | | | 0x3-x4 width |
| | | | 0×4-x8 width |
| | | | 0×5-x10 width |
| | | | 0×6-x12 width |
| | | | 0x7-0xF - reserved |
| 31:24 | 8 | Speed | 0x0 - use default |
| | | | 0x1 − HHDR = 10.3125/4 = |
| | | | 2.578125 Gb/s |
| | | | 0x2 − HDR [half data rate] = |
| | | | 10.3125/2 = 5.15625 Gb/s |
| | | | 0x3 - high speed - 10.3125 Gb/s |
| | | | 0x4-0xF - reserved |
| 23:16 | 8 | Ack | This field indicates whether the |
| | | | message is acknowledged or not - |
| | | | 0x0 - message NACK |
| | | | 0x1 - message ACK |
| | | | 0x2-0xF - reserved |
| 15:0 | 16 | Reserved | |

1. A method for communication, comprising:
establishing a full-duplex communication link between first and second nodes, the link comprising multiple first lanes for conveying first communication traffic in a first link direction from the first node to the second node and multiple second lanes for conveying second communication traffic in a second link direction from the second node to the first node;
exchanging signals between the first and second nodes to indicate a requested change in lane activity in the first link direction; and
responsively to the signals, changing a number of the first lanes that are active so that the first node conveys the first communication traffic to the second node over a first number of the first lanes, while the second node conveys the second communication traffic to the first node over a second number of the second lanes, which is different from the first number.

2. The method according to claim 1, wherein the link comprises equal numbers of the first and second lanes.

3. The method according to claim 1, wherein exchanging the signals comprises detecting a status of the first communication traffic, and initiating an exchange of the signals responsively to the status.

4. The method according to claim 3, wherein detecting the status comprises detecting, at the first node, a level of a queue of packets for transmission by the first node.

5. The method according to claim 4, wherein detecting the level comprises detecting that the queue is empty, and wherein changing the number comprises deactivating one or more of the first lanes.

6. The method according to claim 1, wherein changing the number of the first lanes comprises deactivating all but a single one of the first lanes, so that the first communication traffic is transmitted over the single one of the first lanes while the second communication traffic is transmitted over the multiple second lanes.

7. The method according to claim 1, wherein the first number is greater than one and less than a total number of the first lanes.

8. The method according to claim 1, wherein changing the number of the first lanes comprises setting the first and second numbers independently of one another.

9. The method according to claim 1, and comprising changing a data rate of one or more of the first lanes that are active.

10. Communication apparatus, comprising:
an interface, which is configured to communicate via a full-duplex link with a communication node, the link comprising multiple first lanes for conveying first communication traffic in a first link direction from the interface to the communication node and multiple second lanes for conveying second communication traffic in a second link direction from the communication node to the interface; and
a controller, which is configured to exchange signals with the communication node with respect to a requested change in lane activity in one of the first and second link directions, and responsively to the signals, to change a number of the lanes that are active in the one of the first and second link directions so that the interface conveys the first communication traffic to the communication node over a first number of the first lanes, while the communication node conveys the second communication traffic to the interface over a second number of the second lanes, which is different from the first number.

11. The apparatus according to claim 10, wherein the link comprises equal numbers of the first and second lanes.

12. The apparatus according to claim 10, wherein the controller is configured to detect a status of the first communication traffic, and to initiate an exchange of the signals responsively to the status.

13. The apparatus according to claim 12, wherein the apparatus comprises a queue of packets for transmission to the node over the link, and wherein the controller is configured to detect a level of the queue and to initiate the exchange of the signals responsively to the level.

14. The apparatus according to claim 13, wherein the controller is configured to deactivate one or more of the first lanes in response to detecting that the queue is empty.

15. The apparatus according to claim 10, wherein the controller is configured to deactivate all but a single one of the first lanes, so that the first communication traffic is transmitted over the single one of the first lanes while the second communication traffic is transmitted over the multiple second lanes.

16. The apparatus according to claim 10, wherein the first number is greater than one and less than a total number of the first lanes.

17. The apparatus according to claim 10, wherein the controller is configured to set the first and second numbers independently of one another.

18. The apparatus according to claim 10, wherein the controller is configured to change a data rate of one or more of the first lanes that are active.

19. A communication system, comprising first and second nodes, which are coupled to communicate via a full-duplex communication link, comprising multiple first lanes for conveying first communication traffic in a first link direction from the first node to the second node and multiple second lanes for conveying second communication traffic in a second link direction from the second node to the first node,
wherein the first and second nodes are configured to exchange signals to indicate a requested change in lane activity in the first link direction and responsively to the signals, to change a number of the first lanes that are active so that the first node conveys the first communication traffic to the second node over a first number of the first lanes, while the second node conveys the second communication traffic to the first node over a second number of the second lanes, which is different from the first number.

20. The system according to claim 19, wherein the link comprises equal numbers of the first and second lanes.

21. The system according to claim 19, wherein the first node is configured to detect a status of the first communication traffic, and to initiate an exchange of the signals responsively to the status.

22. The system according to claim 21, wherein the first node comprises a queue of packets for transmission to the node over the link and is configured to detect a level of the queue and to initiate the exchange of the signals responsively to the level.

23. The system according to claim 22, wherein the first node is configured to deactivate one or more of the first lanes in response to detecting that the queue is empty.

24. The system according to claim 19, wherein the first and second nodes are configured to deactivate all but a single one of the first lanes, so that the first communication traffic is transmitted over the single one of the first lanes while the second communication traffic is transmitted over the multiple second lanes.

25. The system according to claim 19, wherein the first number is greater than one and less than a total number of the first lanes.

26. The system according to claim 19, wherein the first and second nodes are configured to set the first number independently of the second number.

27. The system according to claim 19, wherein the first and second nodes are configured to change a data rate of one or more of the first lanes that are active.
